(19) United States
(12) Patent Application Publication
(10) Pub. No.: US 2024/0166091 A1
(43) Pub. Date: May 23, 2024

(54) CRUISING RANGE ESTIMATION METHOD

(71) Applicant: TOYOTA JIDOSHA KABUSHIKI KAISHA, Toyota-shi (JP)

(72) Inventor: Keiji KISHIDA, Toyoake-shi (JP)

(73) Assignee: TOYOTA JIDOSHA KABUSHIKI KAISHA, Toyota-shi (JP)

(21) Appl. No.: 18/464,584

(22) Filed: Sep. 11, 2023

(30) Foreign Application Priority Data
Nov. 22, 2022 (JP) 2022-186676

(51) Int. Cl. B60L 58/30

(52) U.S. Cl. CPC B60L 58/30

(57) ABSTRACT

The cruising range estimation method includes: a collection step of collecting a plurality of fuel consumption learning values corresponding to a plurality of fuel cell electric vehicle from a plurality of fuel cell electric vehicle; a generation step of generating fuel consumption data indicating a temporal change in fuel consumption based on the plurality of fuel learning values; a calculation step of calculating a correction value for correcting the latest fuel consumption learning value based on the latest fuel consumption learning value of one fuel cell electric vehicle and the fuel consumption data when there is a demand from one of the plurality of fuel cell electric vehicle; a transmission step of transmitting the calculated correction value to one fuel cell electric vehicle; and a correction step of correcting the latest fuel consumption learning value using the correction value by the one fuel cell electric vehicle.

### CROSS-REFERENCE TO RELATED APPLICATION

This application claims priority to Japanese Patent Application No. 2022-186676 filed on Nov. 22, 2022 incorporated herein by reference in its entirety.

### BACKGROUND

### 1. Technical Field

The present disclosure relates to a cruising range estimation method.

### 2. Description of Related Art

As a method of this type, for example, a method has been proposed in which fuel consumption is learned when a fuel cell electric vehicle is filled with fuel and a possible cruising range is calculated (see Japanese Unexamined Patent Application Publication No. 2021-118658 (JP 2021-118658 A)).

### SUMMARY

In the technique described in JP 2021-118658 A, fuel consumption is learned at the time of fuel replenishment. When the frequency of the fuel replenishment is relatively low, for example, the opportunity to learn the fuel consumption by machine learning is also relatively small. Then, there is a technical problem that the accuracy of the possible cruising range calculated using the learned fuel consumption is deteriorated.

The present disclosure has been made in view of the above problems, and an object of the present disclosure is to provide a cruising range estimation method capable of improving the accuracy of the possible cruising range even when the frequency of the fuel replenishment is relatively low.

A cruising range estimation method according to an aspect of the present disclosure includes:
a collecting step of collecting, from a plurality of fuel cell electric vehicles, a plurality of fuel consumption learning values corresponding to each of the fuel cell electric vehicles;
a generating step of generating fuel consumption data indicating a temporal change in fuel consumption based on the fuel consumption learning values;
a calculating step of calculating, based on the latest fuel consumption learning value of one fuel cell electric vehicle of the fuel cell electric vehicles, and the fuel consumption data, a correction value for correcting the latest fuel consumption learning value, when there is a demand from the one fuel cell electric vehicle;
a transmitting step of transmitting the calculated correction value to the one fuel cell electric vehicle; and
a correcting step of correcting the latest fuel consumption learning value using the correction value by the one fuel cell electric vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a server apparatus according to an embodiment;

FIG. 2 is a diagram illustrating an example of a temporal change in fuel consumption;

FIG. 3 is a flowchart illustrating a first operation according to the embodiment;

FIG. 4 is a flow chart showing a second operation according to the embodiment; and

FIG. 5 is a flowchart illustrating a third operation according to the embodiment.

### DETAILED DESCRIPTION OF EMBODIMENTS

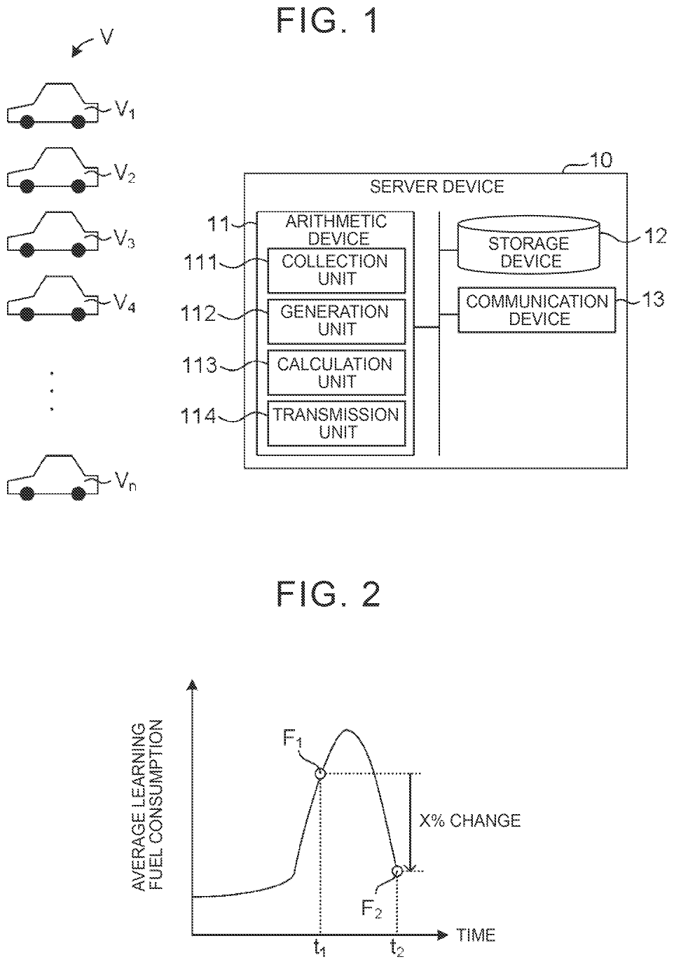

An embodiment of a cruising range estimation method will be described with reference to FIGS. 1 to 5. A configuration to which the cruising range estimation method is applied will be described with reference to FIG. 1. In FIG. 1, the server device 10 includes an arithmetic device 11, a storage device 12, and a communication device 13. The arithmetic device 11 includes a collection unit 1111, a generation unit 112, a calculation unit 113, and a transmission unit 114. The collection unit 1111, the generation unit 112, the calculation unit 113, and the transmission unit 114 may be logically configured processing blocks. The collection unit 1111, the generation unit 112, the calculation unit 113, and the transmission unit 114 may be physically implemented processing circuits. The server device 10 is configured to be able to communicate with a plurality of fuel cell electric vehicle V via the communication device 13.

The plurality of fuel cell electric vehicles V is so-called connected cars. Fuel cell electric vehicle V contain fuel cell electric vehicle V₁, V₂, V₃, V₄, . . . Vₙ. Fuel cell electric vehicle V₁, V₂, V₃, V₄, . . . Vₙ are fuel cell electric vehicle of the same type. Note that a system including the server device 10 and a plurality of fuel cell electric vehicle V may be referred to as a cruising range estimation system.

Each of the plurality of fuel cell electric vehicle V calculates a learning value of fuel consumption of the own vehicle based on an actual performance in actual traveling (for example, an actual traveling distance and an actual consumed fuel amount). The learning value of the fuel consumption is hereinafter referred to as “fuel consumption learning value” as appropriate. Each of the plurality of fuel cell electric vehicle V calculates a fuel consumption learning value at a predetermined timing (for example, at the time of refueling). Each of the plurality of fuel cell electric vehicle V updates the fuel consumption learning value when the fuel consumption learning value is newly calculated. Each of the plurality of fuel cell electric vehicle V estimates a cruising distance (or cruising distance) of the own vehicle based on the fuel consumption learning value and the remaining amount of the fuel. As a method of calculating the fuel consumption learning value, various existing aspects can be applied. Therefore, a detailed description of a method of calculating the fuel consumption learning value will be omitted.

The usage frequency of each of the plurality of fuel cell electric vehicle V differs. Therefore, the frequency of updating the fuel consumption learning value of each of the plurality of fuel cell electric vehicle V also differs. Here, the fuel consumption of fuel cell electric vehicle is relatively greatly influenced by the outside air temperature. When the outside air temperature is relatively low, fuel is consumed more than when the outside air temperature is relatively high due to at least one of control for avoiding freezing of generated water and heating utilization. Therefore, when the frequency of updating the fuel consumption learning value is relatively low, there is a possibility that the fuel consumption learning value and the actual fuel consumption are relatively significantly different from each other. Then, there is a possibility that an error between the cruising distance estimated based on the fuel consumption learning value and the actual cruising distance becomes relatively large.

The server device 10 calculates a correction value for correcting the fuel consumption learning value by an operation described below. The collection unit 111 of the server device 10 collects, from the plurality of fuel cell electric vehicle V, a plurality of fuel consumption learning values corresponding to the plurality of fuel cell electric vehicle V. respectively. The collection unit 111 adds time information (for example, a time stamp) indicating the collected date to each of the plurality of fuel consumption learning values. The collection unit 111 stores a plurality of fuel consumption learning values in the storage device 12.

The generation unit 112 extracts the fuel consumption learning values of the same date from among the plurality of fuel consumption learning values stored in the storage device 12. The generation unit 112 calculates an average value of the extracted fuel consumption learning values. The generation unit 112 stores the calculated average value in the storage device 12 in association with the date of the extracted fuel consumption learning value. The average value of the fuel consumption learning values is hereinafter referred to as “average learned fuel consumption” as appropriate. The generation unit 112 repeatedly performs the same processing to generate time-series data of the average learning fuel consumption. When the generated time-series data is represented by a graph, a temporal change in average learned fuel consumption as shown in FIG. 2 appears.

When one fuel cell electric vehicle of the plurality of fuel cell electric vehicle V (e.g., fuel cell electric vehicle V₁) estimates the cruising distance, the one fuel cell electric vehicle transmits, to the server device 10, the date when the fuel consumption learning value of the one vehicle is last updated. The calculation unit 113 of the server device 10 specifies the average learning fuel consumption F₁ corresponding to the date (e.g., time t₁) transmitted from one fuel cell electric vehicle from the time-series data (see FIG. 2). The calculation unit 113 specifies the average learning fuel consumption F₂ corresponding to the most recent time (e.g., time t₂) in the time series. The calculation unit 113 calculates the correction by comparing the average learning fuel consumption F₁ with the average learning fuel consumption F₂. When the average learning fuel consumption F₂ is a value X % smaller than the average learning fuel consumption F₁, the corrected value may be expressed as (1−X/100).

The transmission unit 114 of the server device 10 transmits the corrections to one fuel cell electric vehicle via the communication device 13. One fuel cell electric vehicle corrects the fuel consumption learning value by multiplying the correction value transmitted from the server device 10 by its own fuel consumption learning value. One fuel cell electric vehicle uses the corrected fuel consumption learning values to estimate the range. Note that one fuel cell electric vehicle for estimating the cruising distance includes a case where the remaining cruising distance is displayed on the instrument panel, and a case where the navigational device determines whether or not to reach the destination.

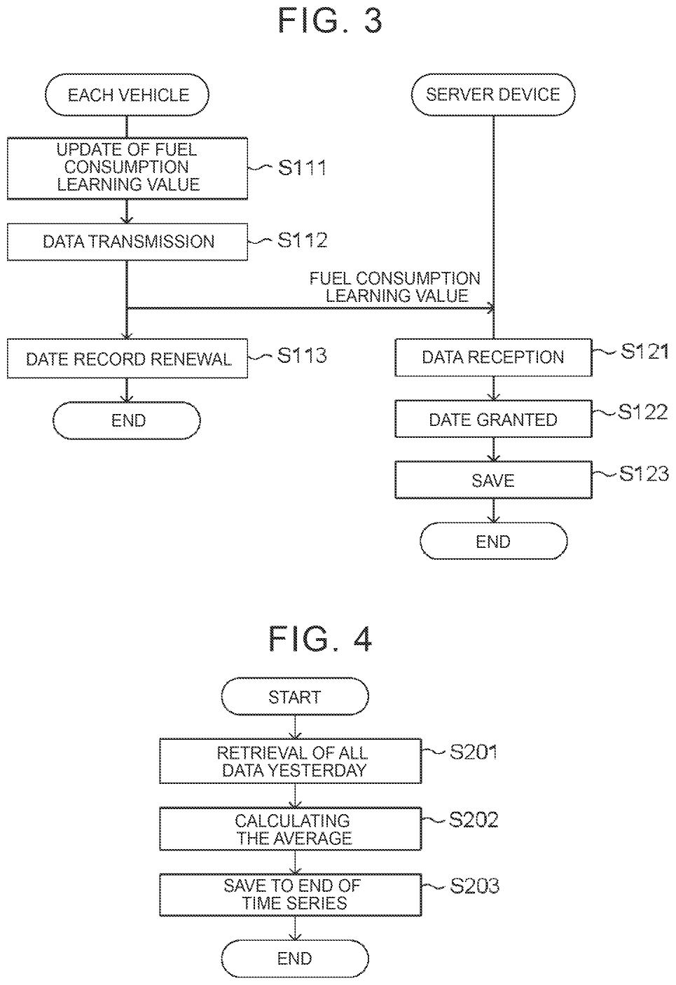

The operation of each of the plurality of fuel cell electric vehicle V and the server device 10 will be described referring to the flow charts of FIGS. 3 to 5. In FIG. 3, when the fuel consumption learning value is updated (S111), each of the plurality of fuel cell electric vehicle V transmits data indicating the fuel consumption learning value to the server device 10 (S112). In parallel with S112 process, each of the plurality of fuel cell electric vehicle V updates the recording indicating the date when the fuel consumption learning value is updated (S113). It should be noted that the records indicating the dates when the fuel consumption learning values are updated may be stored in the memories of the plurality of fuel cell electric vehicle V.

The collection unit 111 of the server device 10 receives the fuel consumption learning value from each of the plurality of fuel cell electric vehicle V (S121). The collection unit 111 adds time-information indicating the received date to the received fuel consumption learning value (S122), and stores the received time-information in the storage device 12 (S123). The delay of communication between each of the plurality of fuel cell electric vehicle V and the server device 10 is sufficiently small. Therefore, the date on which the fuel consumption learning values of the plurality of fuel cell electric vehicle V are updated is the same as the date indicated by the time-information given to the fuel consumption learning values by the server device 10.

In FIG. 4, the generation unit 112 of the server device 10 extracts, from the storage device 12, a plurality of fuel consumption learning values to which the time information indicating the date of the previous day and month is added (S201). The generation unit 112 calculates an average value (i.c., average learned fuel consumption) of the plurality of fuel consumption learning values extracted in S201 process (S202). The generation unit 112 additionally stores the calculated average learned fuel consumption at the end of the time-series data of the average learned fuel consumption (S203). At this time, the average learned fuel consumption calculated in S202 process is associated with the date of the previous day. The generation unit 112 performs the operations illustrated in the flowchart of FIG. 4 every day. Note that the server device 10 may delete a plurality of fuel consumption learning values used for calculating the average learning fuel consumption from the storage device 12. With this configuration, the storage capacity of the storage device 12 can be saved.

When each of the plurality of fuel cell electric vehicle V estimates the cruising range, each of the plurality of fuel cell electric vehicle V calls a recording indicating the date when the fuel consumption learning value was updated last time (S311). Each of the plurality of fuel cell electric vehicle V transmits data indicating the called date to the server device 10 (S312). The calculation unit 113 of the server device 10 receives the date from each of the plurality of fuel cell electric vehicle V (S321). The calculation unit 113 extracts, from the time-series data of the average learned fuel consumption, the average learned fuel consumption corresponding to the date indicated by the data received in S321 process and the average learned fuel consumption of the previous day (in other words, the most recent hour) (S322). The calculation unit 113 calculates a correction value based on the average learned fuel consumption extracted in S322 process (S323).

The transmission unit 114 of the server device 10 transmits data indicating the correction value calculated in S323 process to one fuel cell electric vehicle of the plurality of fuel cell electric vehicle V via the communication device 13 (S324). One fuel cell electric vehicle corrects the learned fuel consumption value based on the received correction value (S313). One fuel cell electric vehicle then S314 the cruising range estimation using the corrected fuel consumption learning values.

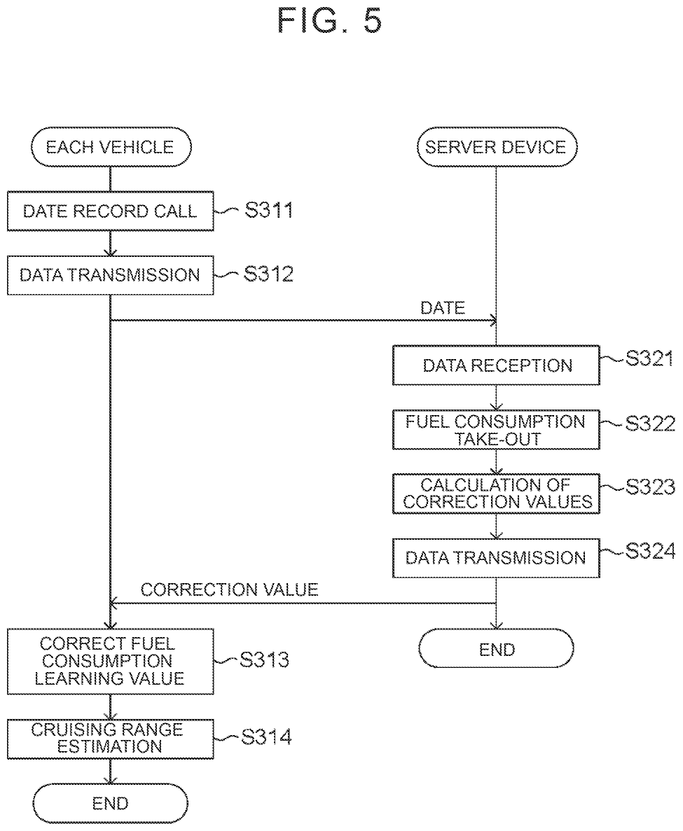

Note that each of the plurality of fuel cell electric vehicle V does not have to perform the operation illustrated in the flow chart of FIG. 5 every time the cruising range is estimated. Each of the plurality of fuel cell electric vehicle V may store the correction-value transmitted from the server-device 10. Each of the plurality of fuel cell electric vehicle V may estimate the cruising distance by correcting the fuel consumption learning value using the correction value stored in the memories as long as the date does not change. Note that each of the plurality of fuel cell electric vehicle V does not need to perform the operation illustrated in the flow chart of FIG. 5 when the elapsed time from the date when the fuel consumption learning value was last updated is equal to or less than a predetermined time (for example, 14 days).

### Technical Effect

The fuel consumption learning value of each of the plurality of fuel cell electric vehicle V is calculated based on the actual performance in the actual traveling. The actual amount of fuel consumed is influenced by, for example, at least one of the individuality of the driver, the condition of the road that is frequently traveled, and the performance of the fuel cell. Therefore, it can be said that the fuel consumption learning values of the plurality of fuel cell electric vehicle V are values reflecting the individuality of the drivers.

On the other hand, the time-series data of the average learned fuel consumption generated by the generation unit 112 of the server device 10 is constituted by the average values of the plurality of fuel consumption learning values. Therefore, it can be said that the individuality of the driver is not reflected in the average learning fuel economy. However, since the average learning fuel consumption is calculated on a daily basis, it can be said that the influence of the element that changes on a daily basis is reflected in the average learning fuel consumption. Outside air temperature is the most influential factor on fuel economy among the factors that change from day to day. Therefore, it can be said that the temporal change (that is, the time-series data) of the average learned fuel consumption illustrated in FIG. 2 reflects the variation of the outside air temperature. Therefore, it can be said that the correction value calculated based on the time-series data of the average learned fuel consumption is a value for correcting the influence of the outside air temperature on the fuel consumption.

As described above, the fuel consumption learning values of the plurality of fuel cell electric vehicle V are values reflecting the individuality of the drivers. In the present embodiment, the fuel consumption learning value reflecting the individuality of the driver or the like is corrected by the correction value for correcting the influence of the outside air temperature on the fuel consumption. Therefore, the corrected fuel consumption learning value is a value in which the individuality of the driver and the influence of the outside air temperature on the fuel consumption are appropriately reflected. The accuracy of the cruising distance estimated using the corrected fuel consumption learning value is higher than that in the case of using the corrected fuel consumption learning value. Therefore, according to the present embodiment, it is possible to improve the accuracy of the estimated cruising distance even when the frequency of updating the fuel consumption learning value is relatively low. That is, according to the present embodiment, it is possible to improve the accuracy of the cruising distance even when the fuel consumption learning value is updated when the fuel is replenished and the frequency of the fuel replenishment is relatively low.

### Modification

In the above-described embodiment, each of the plurality of fuel cell electric vehicle V stores the fuel consumption learning value and the date on which the fuel consumption learning value is updated. The fuel consumption learning values of the plurality of fuel cell electric vehicle V and the date on which the fuel consumption learning values are updated may be stored in the server device 10. In the above-described embodiment, the date when the fuel consumption learning value is updated is stored. In addition to the date when the fuel consumption learning value is updated, a time or a time zone when the fuel consumption learning value is updated may be stored.

In the above-described embodiment, it is assumed that the plurality of fuel cell electric vehicle V is all of the same type. In practice, however, there are various types of fuel cell electric vehicle. Therefore, a correspondence table between ID of vehicles and the type may be generated or updated at the time of manufacturing or repair of fuel cell electric vehicle. The correspondence table may be stored in the server device 10. When the server device 10 receives the fuel consumption learning value from each of the plurality of fuel cell electric vehicle V, the received fuel consumption learning value may be assigned with the type based on the vehicle ID and the correspondence table. The server device 10 may generate time-series data of the average learning fuel consumption for each type indicated by the information given to the fuel consumption learning value.

For example, at the time of manufacturing or repairing fuel cell electric vehicle, a correspondence table between the vehicle ID and the shipping area or the use area may be generated or updated. The correspondence table may be stored in the server device 10. When the server device 10 receives the fuel consumption learning value from each of the plurality of fuel cell electric vehicle V, the received fuel consumption learning value may be assigned with information indicating the shipping area or the use area based on the vehicle ID and the correspondence table. The server device 10 may generate time-series data of the average learned fuel consumption for each shipping area or use area indicated by the information given to the fuel consumption learning value. Instead of the correspondence table, position information (for example, Global Positioning System (GPS)) information indicating the positions of the plurality of fuel cell electric vehicle V may be assigned to the fuel consumption learning value. In this case, the server device 10 may generate time-series data of the average learning fuel consumption for each region based on the position information given to the fuel consumption learning value.

In the above-described embodiment, the average learning fuel consumption is calculated in consideration of the latest update date of the fuel consumption learning value. In addition to the latest update date of the fuel consumption learning value, the average learning fuel consumption may be calculated in consideration of the update date immediately before the latest update date. In this case, the server device 10 may classify the plurality of fuel consumption learning values based on the period between the latest update date and the update date immediately before the latest update date (for example, the plurality of fuel consumption learning values may be classified into one week or less, one month or less, three months or less, or the like). The server device 10 may generate time-series data of the average learning fuel consumption for each period based on the classified fuel consumption learning values. When the server device 10 calculates the correction value, the server device 10 may calculate the correction value on the basis of the time-series data of the averaged learning fuel consumption corresponding to the duration between the latest update date of the fuel consumption learning value of one fuel cell electric vehicle and the update date immediately before the latest update date.

The server device 10 may include a predictor constructed by machine learning instead of the collection unit 111, the generation unit 112, and the calculation unit 113. The predictor may be a learning model that outputs a “change rate of the fuel consumption learning value” when the “date on which the fuel consumption learning value is updated” and the “number of days elapsed from the date on which the fuel consumption learning value is updated to the present” are input.

In the above-described embodiment, the average learned fuel consumption is calculated based on the date when the fuel consumption learning value is updated, time-series data is generated, and a correction value is calculated. An outside air temperature may be used instead of the renewal date. That is, the fuel consumption learning value and the average outside air temperature may be associated with each other. The outside air temperature may be measured by a temperature sensor included in each of the plurality of fuel cell electric vehicle V. The server device 10 may calculate the average learned fuel consumption for each average outdoor air temperature. When the server device 10 calculates the correction value, the server device 10 may calculate the correction value on the basis of the average learning fuel consumption corresponding to the average outside air temperature associated with the fuel consumption learning value of one fuel cell electric vehicle and the average learning fuel consumption corresponding to the present outside air temperature.

Aspects of the disclosure derived from the above-described embodiments and modifications are described below.

A cruising range estimation method according to an aspect of the present disclosure includes: a collection step of collecting, from a plurality of fuel cell electric vehicle, a plurality of fuel consumption learning values corresponding to the plurality of fuel cell electric vehicle, respectively; a generation step of generating fuel consumption data indicating a temporal change in fuel consumption based on the plurality of fuel learning values; a calculation step of calculating a correction value for correcting the latest fuel consumption learning value on the basis of the latest fuel consumption learning value of the one fuel cell electric vehicle and the fuel consumption data when there is a demand from one of the plurality of fuel cell electric vehicle; a transmission step of transmitting the calculated correction value to the one fuel cell electric vehicle; and a correction step of correcting the latest fuel consumption learning value using the correction value. In the above-described embodiment, “time-series data of average learned fuel consumption” corresponds to an example of “fuel consumption data”.

Fuel cell electric vehicle may include estimating a cruising range using the corrected updated fuel economy learned value.

In the calculation step, the correction value may be calculated on the basis of a first fuel consumption, which is a fuel consumption corresponding to a date associated with the latest fuel consumption learning value, in the fuel consumption data and a second fuel consumption, which is a current fuel consumption in the fuel consumption data. In the above-described embodiment, “average learning fuel consumption F₁” corresponds to an example of “first fuel consumption”, and “average learning fuel consumption F₂” corresponds to an example of “second fuel consumption”.

The correction value may be represented by a ratio of the second fuel consumption to the first fuel consumption.

The present disclosure is not limited to the above-described embodiments, and can be modified as appropriate within the scope and spirit of the disclosure that can be read from the claims and the entire specification, and a cruising range estimation method accompanied by such a change is also included in the technical scope of the present disclosure.

What is claimed is:

1. A cruising range estimation method comprising:
a collecting step of collecting, from a plurality of fuel cell electric vehicles, a plurality of fuel consumption learning values corresponding to each of the fuel cell electric vehicles;
a generating step of generating fuel consumption data indicating a temporal change in fuel consumption based on the fuel consumption learning values;
a calculating step of calculating, based on the latest fuel consumption learning value of one fuel cell electric vehicle of the fuel cell electric vehicles, and the fuel consumption data, a correction value for correcting the latest fuel consumption learning value, when there is a demand from the one fuel cell electric vehicle;
a transmitting step of transmitting the calculated correction value to the one fuel cell electric vehicle; and
a correcting step of correcting the latest fuel consumption learning value using the correction value by the one fuel cell electric vehicle.

2. The cruising range estimation method according to claim 1, wherein the one fuel cell electric vehicle includes a estimating step of estimating a cruising range using the latest fuel consumption learning value that has been corrected.

3. The cruising range estimation method according to claim 1, wherein in the calculating step, the correction value is calculated based on first fuel consumption that is fuel consumption corresponding to a date associated with the latest fuel consumption learning value in the fuel consumption data and second fuel consumption that is current fuel consumption in the fuel consumption data.

4. The cruising range estimation method according to claim 3, wherein the correction value is represented by a ratio of the second fuel consumption to the first fuel consumption.
